(19) United States
(12) Patent Application Publication
(10) Pub. No.: US 2005/0089616 A1
(43) Pub. Date: Apr. 28, 2005

(54) Aseptic process for sterilization of solid products

(76) Inventor: Moshe Elyovich, Herzeliya (IL)

Correspondence Address: DR. MARK FRIEDMAN LTD.;C/o Bill Polkinghorn, Discovery Dispatch, 9003 Florin Way, Upper Marlboro, MD, 20772, US

(21) Appl. No.: 10/693,084

(22) Filed: Oct. 27, 2003

(51) Int. Cl. A23L 3/16

(52) U.S. Cl. 426/521

(57) ABSTRACT

A process and system for aseptic processing of a food containing solid particles, the process including the steps of: (a) providing a particulate food processing system including a first chamber and a second chamber; (b) creating a condition of sterility in the second chamber; (c) heating the food particles in the first chamber in a bulk sterilization step, at a temperature above the ambient temperature, so as to produce sterilized food particles; (d) transferring the sterilized food particles to the second chamber, and (e) flash cooling the sterilized food particles in the second chamber while maintaining the condition of sterility in the second chamber.

### FIELD AND BACKGROUND OF THE INVENTION

The present invention relates to an aseptic process for the sterilization of foods, and in particular, to an aseptic process for the sterilization of solid food particles in which the sterilization transpires prior to the introduction of the food particles to the final packaging unit or container.

Several kinds of processes for canning food are known. In one widely-used process, schematically illustrated in FIG. 1, non-sterile food is introduced (in step 1) into a non-sterile final packaging unit, typically a can. The can is sealed (step 2), and heated to boil the food (step 3), and is then cooled (step 4).

This process requires that the final packaging unit (FPU) be capable of suitable materials and construction to withstand the heat and pressure necessary to sterilize (and, sometimes, to cook) the food therein. Practically, final packaging unit is limited to conventional, expensive metal cans for most applications.

The process of FIG. 1 is known to produce an inferior-quality product with respect to aseptic processes. This is due, in part, to the much longer heating time associated with the boiling of the food product within the FPU (to ensure that sufficient heat has penetrated through the can to the center of the pack so as to sterilize the entire product, to the temperature gradients within the product resulting from such external heating, and to the characteristically-long time associated with the cooling of the food product within the FPU.

The process of FIG. 1 is also inefficient, and hence expensive, in that each particular FPU must be individually heated, as opposed to performing the sterilization in bulk fashion (continuous or batch), and subsequently introducing the sterilized product to an aseptically-prepared FPU. Such a process is illustrated in a block diagram in FIG. 2. Non-sterile food is introduced into a bulk sterilization stage (step 1). The sterilized food is cooled (step 2), introduced to aseptic FPUs (step 3), and then sealed (step 4) in an aseptic manner.

A high-quality product is obtained by an aseptic process, using an Ultra High Temperature (UHT) process for sterilization, followed by rapid cooling. Such a process appreciably reduces the destruction (by heat) of the food components that provide the organoleptic characteristics of the food product.

In a typical application of this process, a homogenous food is pumped through a pipe heat exchanger having a heating section and a cooling section. In the heating section, steam is used to indirectly raise the temperature of the food so as to sterilize the homogenous food. After an aseptic condition has been achieved, the food passes into the cooling section, and is indirectly cooled, typically to approximately 40 degrees C. The aseptically-prepared homogenous food is subsequently discharged into aseptic containers, which are then aseptically sealed.

There exists a specific aseptic process for tomato paste, in which the product is heated and sterilized by direct injection of steam into the paste as it flows through a pipe. The sterilized paste is then introduced to an aseptic flash cooler for cooling. This process is not commonly used in the food-processing industry, is suitable for pastes only, and is utilized almost exclusively in the processing of tomato paste.

The known aseptic processes, while being considerably more efficient than the in-situ sterilization process of FIG. 1, are generally limited to foods of a homogenous phase, such as juices, pastes, etc. When particulate foods, or foods containing particulate matter, are heated in a bulk sterilization process, additional technological issues are introduced. Agitation/mixing of the sterilization vessel is required to provide even heating throughout the vessel. Poor distribution of heat may result in overcooking of some or all of the food, and/or insufficient sterilization of a portion of the food (e.g., in cooler areas of the vessel). The agitation/mixing solutions are limited, as care must be taken to preserve the physical integrity of the particulate food.

While standard pipe-flow aseptic processing can expedite the heating and cooling of foods that are homogeneous or even liquid foods that contain small particles, when the food is particulate, the particles must be suspended in a liquid to enable the flow, since particles cannot be pumped without liquid. Even so, due to the velocity distribution within the pipe, most particles spend much more time in the system than the fastest particle, such that the bulk of the particles are over-processed. Moreover, since the linear velocities (along the length of the pipe) of most particles are lower then the linear velocity of the carrier fluid, segregation ensues.

In addition, the transport properties of solid foods are such that segregation of particles from other particles on the basis of size and/or density is almost inevitable in most processes. This segregation leads to different characteristic residence times for different kinds or sizes of food particles, which further aggravates the heat distribution problem described hereinabove.

Several novel processes have been developed in an effort to meet the various process challenges of bulk sterilization of solid foods. U.S. Pat. No. 4,929,463 to Meyer, et al., discloses a process in which solid food particles are separated according to size into two components, which are heated separately within a single aseptic processing system. The fraction of large particles is subjected to heating for a longer time than the fraction of small particles. After the bulk sterilization has been completed, the two fractions are recombined. The process taught by U.S. Pat. No. 4,929,463 also provides for a continuous stream treatment of each particulate fraction at respective uni form velocities to avoid the overcooking of specific particles due to overexposure to heat, and to make sure that other particles are not sufficiently sterilized due to underexposure to heat.

The process, however, is complicated and expensive, requiring additional equipment for the parallel processing of the two particulate fractions, in addition to the equipment required for separating and recombining the fi-actions. Moreover, the separation into two particulate fractions is fundamentally inappropriate for particulate foods having a wide particle size distribution (PSD).

It must be further emphasized that U.S. Pat. No. 4,929,463 is unsuitable for processing food particles such as corn kernels, peas, and diced carrots, in the absence of a surrounding liquid medium (e.g., sauce, water etc.).

In another method contending with the various process challenges of aseptic bulk sterilization of particulate foods, developed by Aaron Stephens and Paul Walker of the Department of Agricultural and Biological Engineering at Pennsylvania State University (www.abe.psu.edu/program/grad/stephens.pdf, www.personal.psu.edu/users/a/b/abs115/research/segflow/), a segmented-flow aseptic system continuously processes the food particles, without segregation. In the method, illustrated in FIG. 3, a chain 31 is pulled through a process tube 35 by a drive motor 32 with a feedback level control 33. As shown in FIG. 3a, chain 31 has barriers 31a, forming compartments 31b for containment and processing of the food particles.

Pump 42 feeds food 44 into system 30 of the method. Food particles travel in direction 46 along sterilization and cooling process tube 35, wherein the compartmentalized food undergoes a thorough sterilization regardless of food particle size. To ensure aseptic conditions, steam or compressed sterile gas is fed through inlet 34 at a pressure of 60 lbs/sq. in. into the chamber of drive motor 32. Concurrently, a back-pressure pump 40 is maintained at a pressure of 40 lbs/sq. in. by steam or by sterile, compressed gas injected through inlet 36. Back-pressure pump 40 with feedback level control 41 also serves to pump processed food 48 into containers.

A seal unit 38, illustrated in detail in FIG. 3a, serves to maintain back-pressure and aseptic conditions. Chain 31 with barriers 31a enters seal unit 38 through process tube 35 in direction 46. The body of seal unit 38 is a jacket 38a, having therein a flexible tube 39. The space between flexible tube 39 and jacket 38a is filled with a pressurized control fluid by means of inlet 38b. The pressure of the control fluid creates an envelope around each of the compartments formed between barriers 31a, by maintaining a seal between the edge of each barrier and the inner wall of flexible tube 39.

One advantage of the system is that the distribution of food particles into segments or cells assures a substantially uniform flow of the particles. However, the system is complicated, includes a plethora of moving, interrelating components, and as such, is prone to failure. Moreover, the particles can be advanced along the process only by means of suspension in a carrier liquid; consequently, the heating and the cooling of the particles are indirect. Finally, the process requires a difficult aseptic separation before discharging the aseptic food product from the system. Due to these and other manifest shortcomings, it appears that the system has not been commercially realized to date.

There is, therefore, a recognized need for, and it would be highly advantageous to have, an efficient, robust and inexpensive system for, and method of, processing particulate foods, in which the bulk sterilization is achieved while maintaining substantially uniform heating of the solid food particles conditions, even during rapid heating and cooling operations. Such a system and method would advantageously allow greater flexibility in the choice of the final packaging unit (FPU), e.g., the use of inexpensive, aseptic food receptacles in place of the nearly-universal but expensive metal can, the use of large-capacity packaging (in excess of 10 kg), as well as the use of a greater variety of packaging shapes and sizes. Perhaps most importantly, such a system and method and would also assure a higher-quality food product.

### SUMMARY OF THE INVENTION

According to the teachings of the present invention there is provided a process for the aseptic processing of a food containing solid particles, the process including the steps of: (a) providing a particulate food processing system including a first chamber and a second chamber; (b) creating a condition of sterility in the second chamber; (c) heating the food particles in the first chamber in a bulk sterilization step, at a temperature above the ambient temperature, so as to produce sterilized food particles; (d) transferring the sterilized food particles to the second chamber, and (e) flash cooling the sterilized food particles in the second chamber while maintaining the condition of sterility in the second chamber.

According to another aspect of the present invention there is provided a system for the aseptic processing of food containing solid particles, the system including: a chamber for performing bulk sterilization of food containing solid particles, so as to obtain sterile solid particles; (b) a flash-cooling chamber for aseptic flash cooling of the sterile solid particles under vacuum; (c) a condenser, fluidly connected to the flash-cooling chamber, for condensing water vapor from the flash-cooling chamber; (d) a water inlet for delivering the aseptic water to a liquid phase of the flash chamber, the aseptic water delivered from an aseptic water source, and (e) a control system for maintaining a presence of aseptic water within the flash-cooling chamber so as to retain the physical integrity of the sterilized food particles.

According to further features in the described preferred embodiments, the process further includes the step of: (f) controlling a water balance within the second chamber during step (e), so as to retain a physical integrity of the sterilized food particles.

According to still further features in the described preferred embodiments, the process further includes the step of: (f) controlling a water balance within the second chamber during step (e), such that a requisite amount of water for flash evaporating is delivered, while maintaining a pre-determined liquid level in the second chamber.

According to still further features in the described preferred embodiments, step (f) includes returning condensate evaporated from the second chamber.

According to still further features in the described preferred embodiments, the condensate is a sterile condensate.

According to still further features in the described preferred embodiments, the condensate is produced in a condenser disposed within the second chamber.

According to still further features in the described preferred embodiments, step (t) includes introducing aseptic water from an external source to the second chamber.

According to still further features in the described preferred embodiments, the external source is a pure water source.

According to still further features in the described preferred embodiments, the external source includes aseptic water from the first chamber.

According to still further features in the described preferred embodiments, the process further includes the step of: (f) condensing water that was evaporated in step (e), wherein the condensing is performed in situ within the second chamber.

According to still further features in the described preferred embodiments, the process further includes the step of: (f) creating a condition of sterility in a vessel for receiving the food particles from the second chamber.

According to still further features in the described preferred embodiments, steps (c), (d), and (e) are continuous process steps.

According to still further features in the described preferred embodiments, the first chamber includes a solids conveying unit that enables a substantially constant residence time for the food particles undergoing the bulk sterilization step in the first chamber.

According to still further features in the described preferred embodiments, the solids conveying unit includes a screw conveyor.

According to still further features in the described preferred embodiments, the chamber for performing the bulk sterilization is a first chamber, the flash-cooling chamber is a second chamber, and the system further includes: (f) a mechanism for transferring the sterile food particles from the first chamber to the second chamber.

According to still further features in the described preferred embodiments, the system further includes: (g) a solids conveying unit, disposed within the first chamber, for providing a substantially constant residence time for the food particles undergoing the bulk sterilization.

According to still further features in the described preferred embodiments, the system further includes: (g) a solids conveying unit, disposed within the flash-cooling chamber, the solids conveying unit designed and configured for segregating a flow of the sterile food particles with respect to the liquid phase in the flash-cooling chamber.

According to still further features in the described preferred embodiments, the solids conveying unit includes a screw conveyor.

According to still further features in the described preferred embodiments, the condenser is disposed within the flash-cooling chamber.

According to still further features in the described preferred embodiments, the aseptic water includes aseptic condensate from the condenser.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Throughout the drawings, like-referenced characters are used to designate like elements. Referring now to the drawings:

FIG. 1 is a block diagram of a prior-art canning process in which non-sterile food is sterilized in a non-sterile final packaging unit (FPU); b illustrate typical methods of canning foods in the prior art;

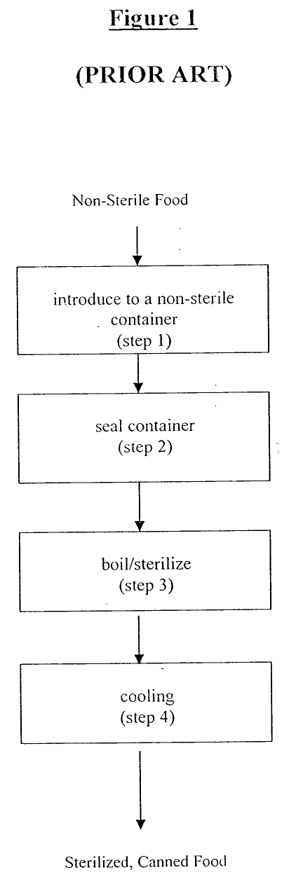

FIG. 2 is a block diagram of a prior-art canning process in which non-sterile food is bulk-sterilized before being delivered to aseptic FPUs;

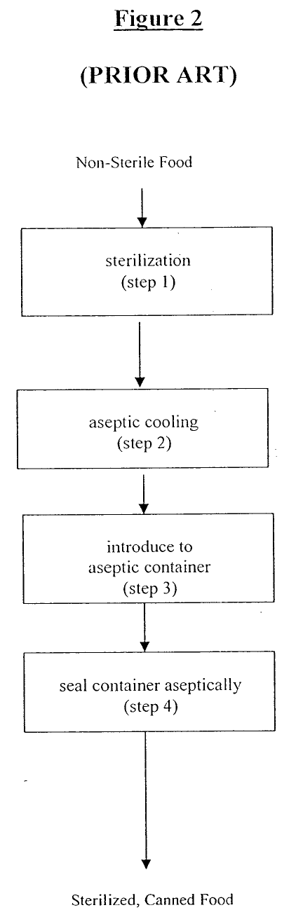

FIG. 3 is a schematic diagram of a prior art segmented-flow system for processing particulate foods;

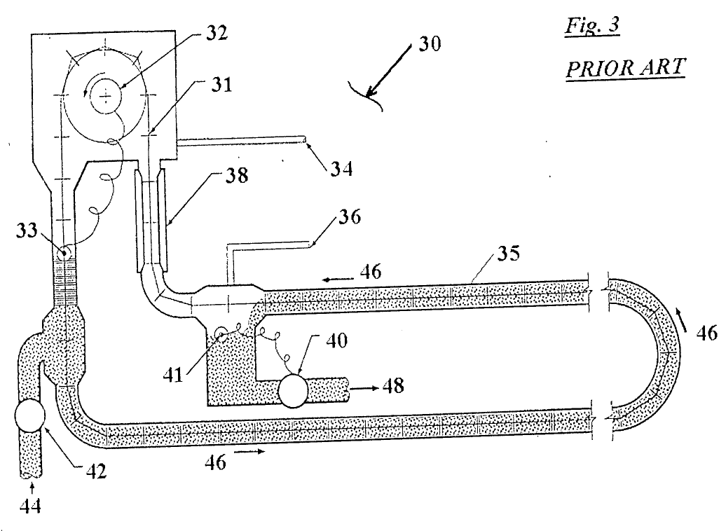

FIG. 3a is a detail view of a seal unit in the segmented-flow system of FIG. 3;

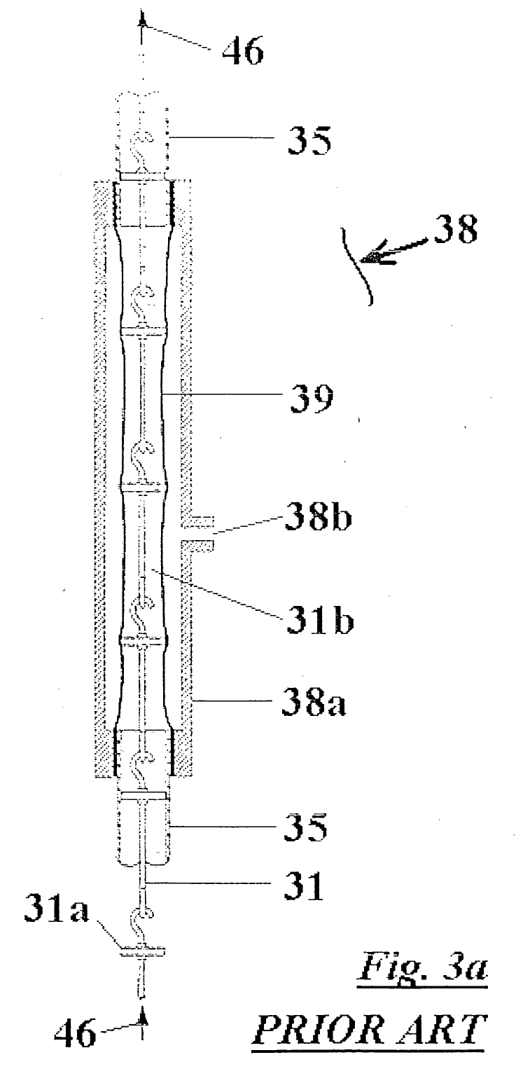

FIG. 4a is a schematic diagram of the system according to one embodiment of the present invention; and

FIG. 4b is a schematic diagram of another embodiment of the inventive system, in which a sterile condenser is disposed externally to a cooling chamber.

### DESCRIPTION OF THE PREFERRED EMBODIMENTS

The present invention is a system for and a method of aseptic processing of particulate foods.

The principles and operation of the method of the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawing. The invention is capable of other embodiments or of being practiced or carried out in various ways. Also, it is to be understood that the phraseology and terminology employed herein is for the purpose of description and should not be regarded as limiting.

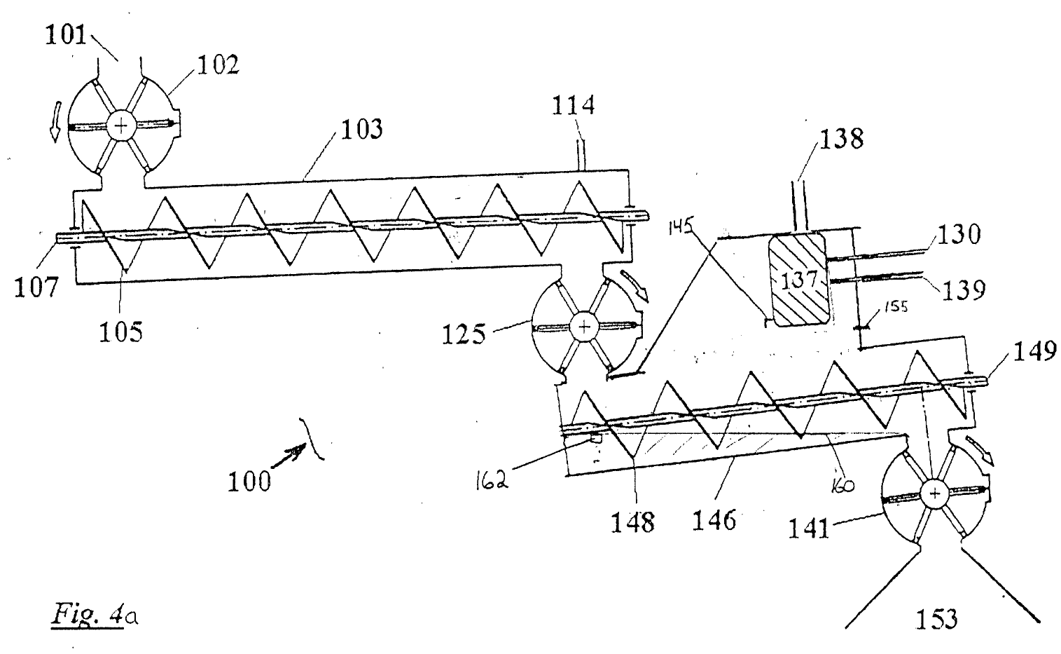

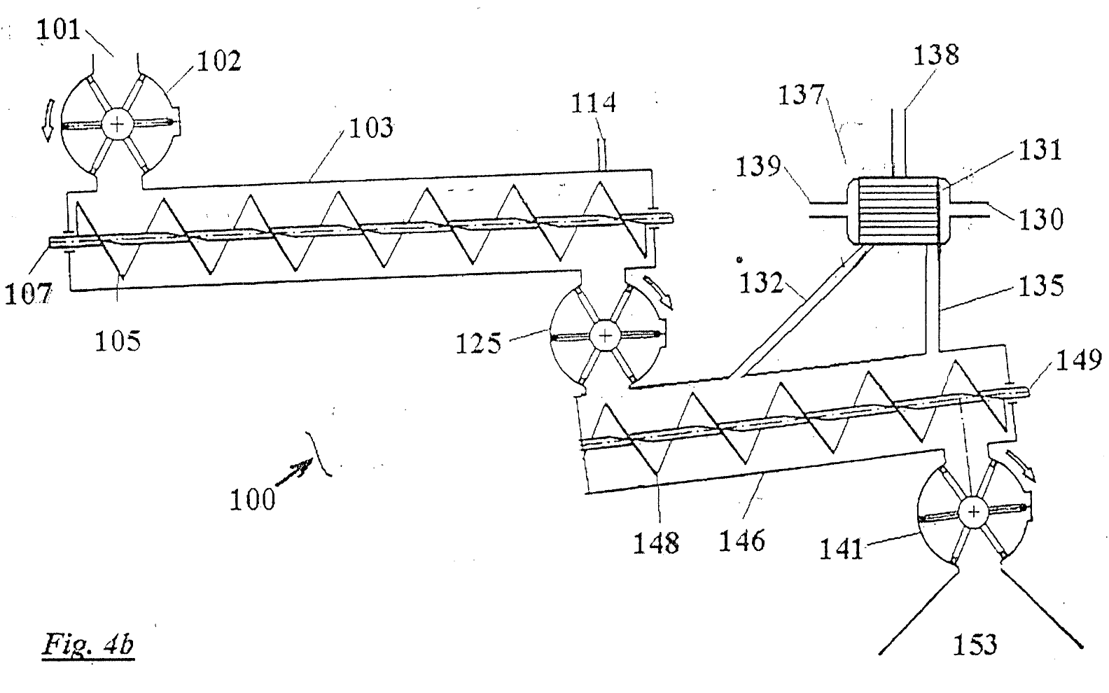

Referring to FIG. 4, system 100 of the present invention includes a sterilization chamber 103 having a longitudinal screw conveyor 105 rotating on axis 107, a cooling chamber 146, star valves 102, 125 and 141, and a sterile condenser 137 disposed Within cooling chamber 146. Cooling chamber 146 contains a longitudinal screw conveyor 148 rotating on axis 149.

A particulate food to be processed is introduced to star valve 102 via a solid food inlet 101. Star valve 102 admits the food into sterilization chamber 103, wherein the particulate food is subjected to high-temperature, high-pressure steam introduced through a steam inlet 114, until the food is rendered sterile. The food can also be sterilized therein using other known methods. The residence time of the food in the chamber can be controlled by the varying the speed, measured in revolutions per minute (RPM), of screw conveyor 105.

It must be emphasized that screw conveyor 105 provides system 100 with a characteristic residence time for the food particles that is largely independent of particle size.

To this end, the system of the present invention may advantageously utilize, to a large extent, various systems and technologies known in the art. For example, U.S. Pat. No. 6,056,987 to Frenkel, et al., which is incorporated by reference for all purposes, as if fully set forth herein, teaches a flash-peeling system for removing tomato peels. The tomatoes are heated to a high temperature and pressure, and are subsequently subjected to a lower temperature and pressure, wherein the resultant flash-peeling tears the skin off from the body of the tomatoes. Although U.S. Pat. No. 6,056,987 does not teach an aseptic process, nor is the flash chamber disclosed therein designed to preserve the integrity of the food particles (on the contrary, the flash chamber is designed such that the water in the outer region of the tomato is vaporized such that the tomato skin is ripped off), some of the unit operations can be applied with facility to the system and method of the present invention.

Referring again to FIG. 4, star valve 125 transfers the sterilized food to cooling chamber 146, while substantially maintaining the pressure differential between sterilization chamber 103 and cooling chamber 146. Cooling chamber 146, which is advantageously configured to operate while being partially-filled with (sterile) water, is evacuated through vacuum line 138, which serves to provide the initial requisite vacuum and to remove non-condensable gases during continuous, steady-state operation. Vacuum line 138 is in fluid communication with the condensing-vapor side of sterile condenser 137, preferably disposed in series with respect to the condensing-vapor side of sterile condenser 137.

Sterile condenser 137 receives cooling water through inlet 130 from an external cooling system (e.g., a cooling tower), and returns the heated cooling water via outlet 139. Vapor within cooling chamber 146 enters sterile condenser 137, wherein the temperature differential between the cooling water and the vapor results in condensation. The condensation of the vapor produces a vacuum, which draws additional vapor into sterile condenser 137.

The condensate is preferably allowed to drip back into cooling chamber 146 via water inlet 145. The condensate is subsequently reevaporated, the rate of evaporation being determined (neglecting losses) by the equation:

$$Evap . rate = \frac{M * Cp * Δ T}{Δ H}$$

wherein M is the mass flow rate of the food stream, Cp is the average specific heat of the food stream introduced to cooling chamber 146 via star valve 125; ΔT is the temperature differential between the food stream introduced and the operating temperature of cooling chamber 146, and ΔH is the specific change in enthalpy of the condensing vapor).

The return of the condensate to cooling chamber 146 substantially obviates the food from having to provide water for the flash-evaporation process. A small make-up stream of sterile water can be introduced via controlled sterile water inlet 155, as needed.

The rapid cooling of the food by the sterile water within cooling chamber 146 reduces the pressure in the particles and prevents flashing of the water in the particles, such that the physical integrity of the solid particles is retained.

The control of liquid level 160 within cooling chamber 146 is important to the operation of system 100. The maximum level of liquid is controlled, by way of example by star valve 141. If liquid level 160 drops below a pre-determined level, as measured by sensor 162, water may be introduced via controlled sterile water inlet 155. Control may be effected mechanically or by means of a processing unit, according to methods that are known to those skilled in the art.

The temperature within sterilization chamber 103 is preferably maintained around 120 degrees C. the actual sterilization temperature being determined, inter alia, by the specific characteristics and requirements of the food product (pH, sensitivity, particle size and distribution, % water, etc.). The temperature within cooling chamber 146 is preferably around 40 degrees C., the temperature corresponding to an absolute pressure of approximately 0.075 kg/cm².

The cooled solid food product is transferred out of cooling chamber 146 by star valve 141, through an aseptic filler 153, and into an aseptic container. The aseptic container may be made of various plastic or other synthetic materials, many of which are not used in traditional processes in which the sterilization is performed within the container.

In an alternative embodiment of the present invention, shown in FIG. 4b, sterile condenser 137 is mounted externally to cooling chamber 146. A vacuum pump (not shown) connects to sterile condenser 137 via vacuum line 138. Sterile condenser 137 receives cooling water through inlet 130 from an external cooling system (e.g., a cooling tower), and returns the heated cooling water via outlet 139. Vapor within cooling chamber 146 enters sterile condenser 137 via vapor line 135, wherein the temperature differential between the cooling water and the vapor results in condensation. Sterile water from sterile condenser 137 is fed into cooling chamber 146 through outlet 132 to provide the requisite water for the flash evaporation operation, as described hereinabove. Alternatively, sterile water is admitted to cooling chamber 146 via star valve 125 or via another inlet (e.g., as shown in FIG. 4a).

In the process of the present invention, sterilization is effected by direct introduction of steam to the particles, and rapid cooling is achieved by flash evaporation, contrary to conventional processes for sterilizing solid particles, in which indirect (surface) heat exchange is used for both heating and cooling of the liquid medium surrounding the particles. Moreover, the efficient thermal treatment provided by the present invention enables the processing of particles of different characteristic size, under the same process conditions.

It must be emphasized that the process of the present invention can be accomplished in batch mode, in addition to continuous mode.

As used herein in the specification and in the claims section that follows, the term “bulk sterilization” refers to sterilization of a large, industrial quantity of food particles within a processing unit, the sterilization being conducted in a continuous, semi-continuous, or batch fashion. The term “bulk sterilization” is specifically meant to exclude sterilization conducted within an FPU.

As used herein in the specification and in the claims section that follows, the term “control system”, used in the context of the flash-cooling chamber, refers to a mechanism for maintaining a pre-determined presence (e.g., level, volume) of liquid within the flash-cooling chamber.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A process for aseptic processing of a food containing solid particles, the process comprising the steps of:
(a) providing a particulate food processing system including:
(i) a first chamber;
(ii) a second chamber;
(b) creating a condition of sterility in said second chamber;
(c) heating said food particles in said first chamber in a bulk sterilization step, at a temperature above the ambient temperature, so as to produce sterilized food particles;
(d) transferring said sterilized food particles to said second chamber, and
(e) flash cooling said sterilized food particles in said second chamber while maintaining said condition of sterility in said second chamber.

2. The process of claim 1, further comprising the step of:
(f) controlling a water balance within said second chamber during step (e), so as to retain a physical integrity of said sterilized food particles.

3. The process of claim 1, further comprising the step of:
(f) controlling a water balance within said second chamber during step (e), such that a requisite amount of water for flash evaporating is delivered, while maintaining a pre-determined liquid level in said second chamber.

4. The process of claim 2, wherein step (f) includes returning condensate evaporated from said second chamber.

5. The process of claim 4, wherein said condensate is a sterile condensate.

6. The process of claim 4, wherein said condensate is produced in a condenser disposed within said second chamber.

7. The process of claim 2, wherein step (f) includes introducing aseptic water from an external source to said second chamber.

8. The process of claim 2, wherein said external source is a pure water source.

9. The process of claim 2, wherein said external source includes aseptic water from said first chamber.

10. The process of claim 1, further comprising the step of:
(f) condensing water that was evaporated in step (e), wherein said condensing is performed in situ within said second chamber.

11. The process of claim 1, further comprising the step of:
(f) creating a condition of sterility in a vessel for receiving said food particles from said second chamber.

12. The process of claim 1, wherein steps (c), (d), and (e) are continuous process steps.

13. The process of claim 1, wherein said first chamber includes a solids conveying unit that enables a substantially constant residence time for said food particles undergoing said bulk sterilization step in said first chamber.

14. The process of claim 13, wherein said solids conveying unit includes a screw conveyor.

15. A system for aseptic processing of food containing solid particles, the system comprising:
(a) a chamber for performing bulk sterilization of food containing solid particles, so as to obtain sterile solid particles;
(b) a flash-cooling chamber for aseptic flash cooling of said sterile solid particles under vacuum;
(c) a condenser, fluidly connected to said flash-cooling chamber, said condenser for condensing water vapor from said flash-cooling chamber;
(d) a water inlet for delivering said aseptic water to a liquid phase of said flash chamber, said aseptic water delivered from an aseptic water source, and
(e) a control system for maintaining a presence of aseptic water within said flash-cooling chamber so as to retain a physical integrity of said sterilized food particles.

16. The system of claim 15, wherein said chamber for performing said bulk sterilization is a first chamber, said flash-cooling chamber is a second chamber, the system further comprising:
(f) a mechanism for transferring said sterile food particles from said first chamber to said second chamber.

17. The system of claim 16, further comprising:
(g) a solids conveying unit, disposed within said first chamber, for providing a substantially constant residence time for said food particles undergoing said bulk sterilization.

18. The system of claim 16, further comprising:
(g) a solids conveying unit, disposed within said flash-cooling chamber, said solids conveying unit designed and configured for segregating a flow of said sterile food particles with respect to said liquid phase in said flash-cooling chamber.

19. The system of claim 18, wherein said solids conveying unit includes a screw conveyor.

20. The system of claim 15, wherein said condenser is disposed within said flash-cooling chamber.

21. The system of claim 15, wherein said aseptic water includes aseptic condensate from said condenser.
